(19) United States
(12) Patent Application Publication
(10) Pub. No.: US 2026/0217569 A1
(43) Pub. Date: Jul. 30, 2026

(54) WATER-COOLED HOLLOW HEAT SINK SYSTEM AND METHOD RELATED APPLICATIONS

(71) Applicant: PENTAIR, INC., Golden Valley, MN (US)

(72) Inventors: Anuj Saini, Ghaziabad (IN); Ajit Tulo, Greater Noida (IN)

(21) Appl. No.: 19/146,713

(22) PCT Filed: Jan. 9, 2024
(86) PCT No.: PCT/US2024/010948

§ 371 Date: Jul. 9, 2025

Related U.S. Application Data
(60) Provisional application No. 63/437,813, filed on Jan. 9, 2023.

(51) Int. Cl. C02F 1/32; B01D 35/143; C02F 1/00

(52) U.S. Cl. CPC C02F 1/325; B01D 35/143; C02F 1/003; C02F 2201/3222; C02F 2303/14

(57) ABSTRACT

A system and method for heat management using a water-cooled hollow heat sink with a UV-C LED reactor in a water filtration system is provided. The system for heat management may include a filter and a base secured together through a threaded connection, with the base including a UV-C reactor heat sink.

### RELATED APPLICATIONS

This application claims priority to U.S. Provisional Patent Application No. 63/437,813 filed Jan. 9, 2023, the entire disclosure of which is incorporated herein by reference.

The disclosure generally relates to heat management for ultraviolet light-emitting diode reactors used to treat fluids. More particularly, the present disclosure provides a system and method for heat management using a water-cooled hollow heat sink with a UV-C LED reactor in a water filtration system or other aquatic application.

### BACKGROUND

Chemical water treatment is the most commonly used method for water disinfection. Although these methods have various advantages, there are numerous drawbacks. The drawbacks include the potential for chemical overdosing of the water, inconsistent consumer acceptance across markets and geographies, and the inherent chemical resistance of some waterborne pathogens like Legionella, Cryptosporidium, Giardia, and Cyclospora.

Due to its universal dose-dependent germicidal action, the use of mercury-based UV lamps is the water disinfection technology with the fastest rising market share. Although mercury-based UV lamps may provide very good protection against pathogens in water, mercury-based lamps are also a significant source of mercury pollution, consume a large amount of electricity, and require frequent cleaning and replacement.

As such, a mercury-free alternative to UV lamps, UV-LEDs are an eco-friendly solution for mercury pollution and clean drinking water. When compared to conventional mercury-based UV lamps, UV-LEDs provide several benefits, including, but not limited to, a small and durable construction, lower voltage and power requirements, and the capacity to switch on and off repeatedly. The benefits make UV-LEDs a desirable replacement for UV lamps in UV reactor systems.

UV (ultraviolet) light is a type of radiation that can be found in the electromagnetic spectrum and is measured in Nanometers (nm). Invisible to the human eye, UV is an effective disinfectant due to the density of its wavelength. When the DNA of microorganisms absorbs UV light, it prevents them from being able to reproduce and duplicate, thereby preventing their growth.

There are four ranges in UV light including UV-A, UV-B, UV-C, and Vacuum-UV. UV-C light has the shortest wavelength, ranging between 200 nm and 280 nm. UV-C light is germicidal, meaning it can be used effectively as a disinfectant to kill microorganisms, such as bacteria and viruses.

Light-emitting diodes (LEDs) may be designed so that a wavelength can be inputted and emit photons in the UV-C range that can be used to stop the replication of bacteria. An LED produces a pre-selected wavelength from a small amount of electricity. The LED then emits UV-C photons through the water that penetrate the cells and damage the nucleic acid in the microorganism's DNA. As such, UV-C LED disinfection is a technology that uses light to damage the DNA of pathogens.

During operation, UV LEDs (and UV-C LEDs) produce a large amount of heat and only convert approximately 5% of the power input into UV light. The remaining 95% of the power is converted into heat that should be removed to maintain the LED junction temperature below its maximum operating temperature (or safe limit for LED efficient working).

UV-C LED disinfection offers a variety of new benefits when compared to conventional mercury-vapor lamps. Some of these benefits include being environmentally friendly, having a small design footprint, instant and unlimited on/off cycles, and more precise wavelength selection. Most notably, UV-C disinfection technology provides treatment without the use of harmful chemicals.

Although LEDs can be temperature-independent, they produce a large amount of heat. Less than 5% of the power input is converted into UV light only and the remaining 95+% of the power converts to heat, which should be quickly removed from a conventional water filtration system to keep the LED junction temperature below its maximum operating temperature. For most systems, the safe limit for LEDs to continue efficiently working is less than 60° C.

Although the use of UV-LEDs in water disinfection has many benefits, one of the most notable drawbacks is that the UV-LEDs utilized in a conventional UV-LED reactor are heated quite significantly when they are in an illumination stage. A UV-LED light used in a UV-LED photoreactor may experience excessive heating that reduces the UV-LED's lifetime, shifts the peak wavelength of the radiation it emits, and/or reduces radiation output. With the right heat management system, a UV-radiation LED's output and/or lifetime performance may be considerably enhanced. Additionally, other electronic components that are electronically coupled to UV-LEDs and/or are located on the same circuit board may be negatively impacted by the heat produced by UV-LEDs.

Current UV disinfection systems use convection cooling in conjunction with the ambient air to dissipate the heat generated by the UV-LEDs. The convection and ambient air cooling methods can be inefficient, especially in enclosed (e.g., small) locations with little airflow.

Therefore, a heat management system designed for use with UV LEDs would be desirable. The disclosed embodiments represent systems and methods that are capable of simultaneously managing heat and treating water for disinfection.

The water circulated inside the heatsink disclosed herein is designed to cool down the surface that is attached to a metal core printed circuit board (MCPCB). Further, the heat is transferred to the circulated water in the heat sink by using a thermal paste. Moreover, the entire process of heat transfer takes place due to conduction among the LEDs to the MCPCB, and from the MCPCB to the heat sink surface. Then, the heat transfers to flowing water by convection from the surface of the heat sink. The water used to cool the MCPCB is transferred for disinfection treatment.

### SUMMARY

Generally, the disclosed embodiments are directed toward a water filtration system with a UV-C reactor heat sink.

A device for heat management is provided. The device includes a housing having a water inlet in communication with a supply of water and a water outlet for discharging water that has passed through the device. The housing defines a passage for adequate circulation of the water. A MCPCB is disposed within the housing. A top surface of the housing is connected to a bottom surface of the MCPCB, and a thermal paste is provided for transferring the heat from the MCPCB.

Moreover, the device is substantially hollow for heat management. The fluid flow passage is provided to cool the bottom surface of the MCPCB and can be provided in different configurations for heat management.

In a further embodiment, a method for heat management of a heat sink is provided. The method comprises providing a fluid for cooling the heat sink and allowing the fluid to pass through a defined passage in the heat sink. The method further includes the steps of providing a thermal paste and discharging the fluid from the heat sink after cooling the MCPCB.

The MCPCB includes one or more UV-LEDs that are used for disinfecting the fluid. The heat sink includes the MCPCB, and the thermal paste layer is disposed between the MCPCB and the heat sink. The fluid is discharged using an outlet in the heat sink.

In addition to the exemplary aspects and embodiments described above, further aspects and embodiments will become apparent by reference to the drawings and by study of the following detailed descriptions.

### DESCRIPTION OF THE DRAWINGS

FIG. 1A illustrates an isometric view of an exemplary water filtration system;

FIG. 1B illustrates an exploded isometric view of the water filtration system of FIG. 1A;

FIG. 1C illustrates an isometric view of a water-cooled hollow heat sink positioned within the water filtration system of FIGS. 1A and 1B;

FIG. 1D illustrates a cross-sectional isometric view of a water-cooled heat sink positioned within an exemplary water filtration system;

FIG. 2A illustrates an isometric view of the bottom side of the water-cooled hollow heat sink;

FIG. 2B illustrates an isometric view of the top side of the water-cooled hollow heat sink;

FIG. 3A illustrates an exploded isometric view of the bottom side of the water-cooled hollow heat sink;

FIG. 3B illustrates an exploded isometric view of the top side of the water-cooled hollow heat sink;

FIG. 4 illustrates a cross-sectional isometric view of the water-cooled hollow heat sink;

FIG. 5 illustrates an isometric view of the inside of the water-cooled hollow heat sink with the top cover removed for clarity; and

FIG. 6 is a block diagram of a method for cooling a water filtration system using the water-cooled hollow heat sink of FIGS. 2A and 2B.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

Aspects of the present disclosure offer apparatus and method for controlling the heat produced by UV-LEDs, which entails discharging that heat resulting in increasing the UV-LEDs' operating lifetime or their output of UV light. The UV-LED reactor is associated with or is otherwise provided in a water disinfection system designed to purify or otherwise disinfect drinking water.

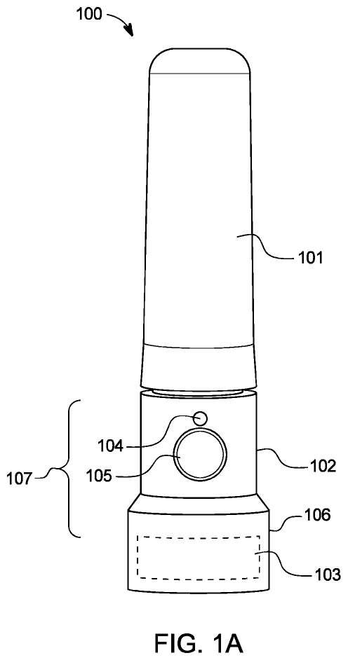

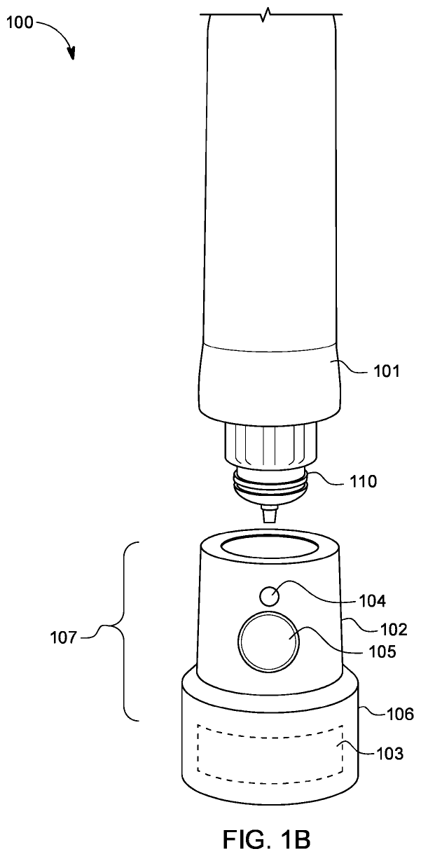

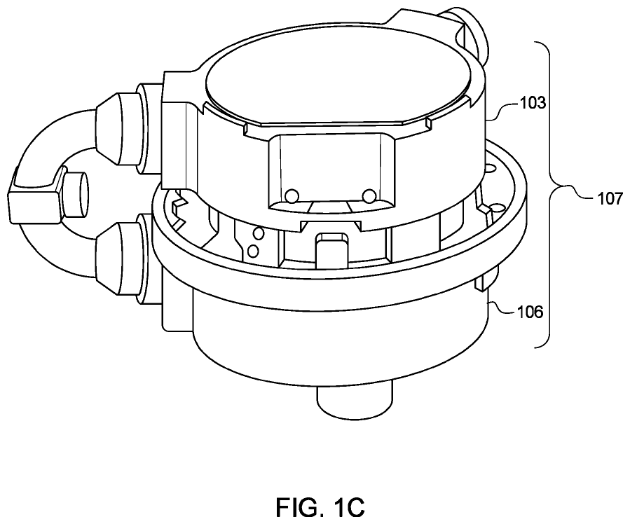

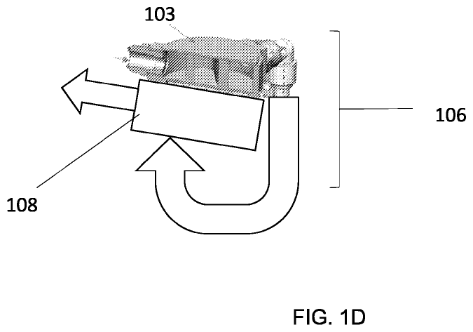

Now turning to FIGS. 1A-D, which illustrate various views of a water filtration system 100. The water filtration system 100 is provided in the form of at least two cylindrical structures defined by a filter 101 and a base 107. The filter 101 and the base 107 are designed to releasably attach via a threaded connector 110. The filter 101 extends upwardly from the base 107 and is designed to filter water flowing therethrough. The water filtration system 100 can be configured to connect to conventional household sinks through an inlet and outlet hose (not illustrated) and be positioned underneath a sink countertop. The filter 101 is configured to decontaminate fluids that flow in and out of the water filtration system 100. Specifically, the filter 101 is configured to reduce the amounts of one or more of perfluorooctanoic acid, perfluorooctane sulfonate, Cryptosporidium, Giardia, lead, or chlorine in household drinking water.

The base 107 is defined by an upper cylindrical portion 102 protruding upwardly from a cylindrical lower portion 106, with the upper portion including an indicator light button 104 and a filter release button 105. The indicator light button 104 can be configured to communicate the status of the filter 101. For example, each blue light flash indicates three months of remaining life for the filter 101 (e.g., two flashes represent six months of remaining life for the filter 101). When the filter needs to be changed, a red light blinks three times, continuing three times daily for eight seconds for 60 days, unless deactivated by pressing the indicator light button 104. Additionally, pressing and holding the indicator light button 104 for five seconds initiates a fifteen-minute timer to flush water through a newly installed filtration system. The indicator light button 104 illuminates a blue color to confirm the timer has started. In another example, if red and blue lights are flashing alternately, the batteries in the water filtration system 100 need to be replaced. Additionally, after installing a new filter 101 in the water filtration system 100, pressing and holding the indicator light button 104 for five seconds will initiate the indicator light button to flash blue lights four times, indicating the remaining life on the new filter 101.

The filter 101 and base 107 of the water filtration system 100 are connected through the threaded connector 110 and a snap-in type connection (not illustrated) provided in the form of the filter release button 105. The filter release button 105 is configured to disengage the filter 101 from the base 107 of the water filtration system 100. By pressing and holding the filter release button 105, a consumer can remove the filter 101 that needs to be replaced from the water filtration system 100 by lifting and twisting the filter 101 in an upward and counterclockwise motion, to unthread and remove the filter 101 from the water filtration system 100.

The lower portion 106 of the base 107 acts as a housing for a water-cooled heat sink 103, as illustrated in FIG. 1C. The lower portion 106 is configured to enclose and protect the heat sink 103 from elements outside of the water filtration system 100.

FIG. 1D illustrates a cross-sectional view of the heat sink 103 positioned in the lower portion 106 of the base 107 of the water filtration system 100. Specifically, FIG. 1D depicts how water supplied to the water filtration system 100 flows into the heat sink 103, through the heat sink 103, out of the heat sink 103, and downwardly into a disinfection chamber 108 (e.g., where UV-C LED based disinfection occurs). In this way, incoming (e.g., untreated) water passes through the heat sink 103 and is then disinfected in an adjacent chamber 108 and is routed out through the water filtration system 100.

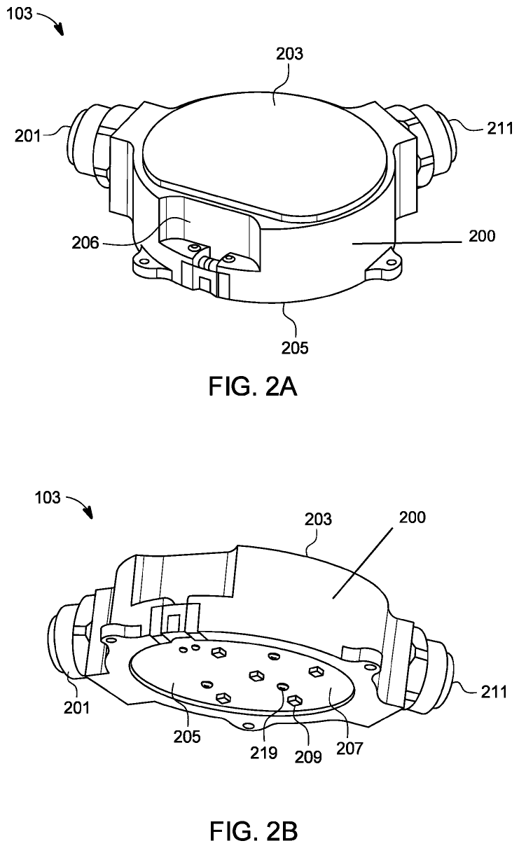

FIGS. 2A-B illustrate various views of the water-cooled heat sink 103. The heat sink 103 is provided in the form of a housing 200 defined by a cylindrical shaped disc having an upper surface 203, a lower surface 205 opposite the upper surface 203, an inlet 201, an outlet 211, and an electrical connector seat 206 positioned on an exterior edge of the heat sink 103 between the inlet 201 and outlet 211.

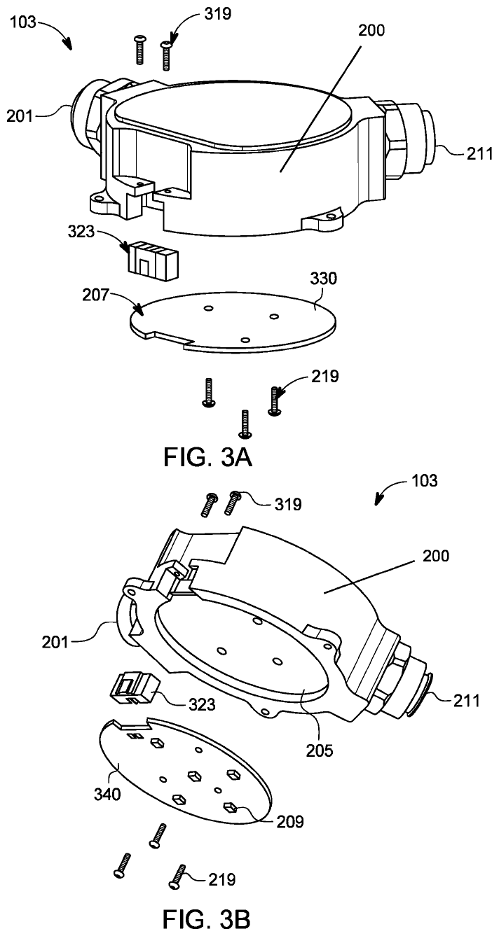

As depicted in FIG. 2A, the upper surface 203 is substantially flat and covers the entirety of the housing 200. As best seen in FIG. 2B, the lower surface 205 includes a circular aperture that includes a metal core printed circuit board (MCPCB) 207 disposed therein. The MCPCB 207 is defined by an interior surface 330 of the MCPCB 207, and an exterior surface 340 of the MCPCB 207, respectively (see FIGS. 3A and 3B). The lower surface 205 of the MCPCB 207 also includes a plurality of UV-C LED lights 209 scattered around and attached to the lower surface 205 of the MCPCB 207. The lower surface 205 may also include a plurality of MCPCB fasteners 219 (see FIG. 3A), which may be provided in the form of screws or any other suitable fastening mechanisms that are designed to secure the MCPCB 207 to the housing 200.

The inlet 201 and the outlet 211 protrude outwardly from the housing 200 and include an opening (not shown) extending therethrough. The inlet 201 is configured to allow fluids, for example, water, to flow into the heat sink 103. The outlet 211 is configured to allow fluids, for example, water, to flow out of the heat sink 103 and into the water filtration system 100 for additional filtration. The inlet 201 and outlet 211 may be in fluid communication with the lower portion 106 (as illustrated in FIG. 1C) of the base 107 of the water filtration system 100. In some forms, the lower portion 106 is configured to provide UV-C LED disinfection.

The MCPCB 207 is designed to retain the plurality of UV-C LED lights 209 on the heat sink 103. The UV-C LED lights 209 are operatively connected to the MCPCB 207 and may be configured to enter an illumination stage, wherein the UV-C LED lights 209 illuminate and disinfect the water that flows adjacent to a surface of the MCPCB 207 of the heat sink 103. While one or more of the UV-C LED lights 209 are in the illumination stage, the temperature of the MCPCB 207 increases. To preserve the proper function of the UV-C LED lights 209 and ultimately the entire water filtration system 100, the MCPCB 207 and the UV-C LED lights 209 are designed to stay below a safe operating temperature. In some embodiments, the safe operating temperature may be below or around 60° C. The heat dissipated by UV-C LED lights 209 is absorbed into water flowing through the heat sink 103.

FIGS. 3A-B illustrate various exploded views of the water-cooled heat sink 103. The heat sink 103 further includes an electrical connector 323 configured to be positioned in the electrical connector seat 206 (as shown in FIGS. 2A and 2B). The electrical connector 323 may be secured to the electrical connector seat 206 by a plurality of electrical connector fasteners 319. The electrical connector 323 is configured to electronically connect the MCPCB 207 with the heat sink 103 and provide power to the UV-C LED lights 209. The electrical connector 323 receives an electrical current from an outside source (not illustrated) and supplies it to the MCPCB 207, thus providing power to the UV-C LED lights 209 and facilitating the illumination stage. The electrical connector fasteners 319 are configured to attach the electrical connector 323 to the heat sink 103 through the electrical connector seat 206. The electrical connector fasteners may be provided in the form of screws or any other suitable fastening mechanism.

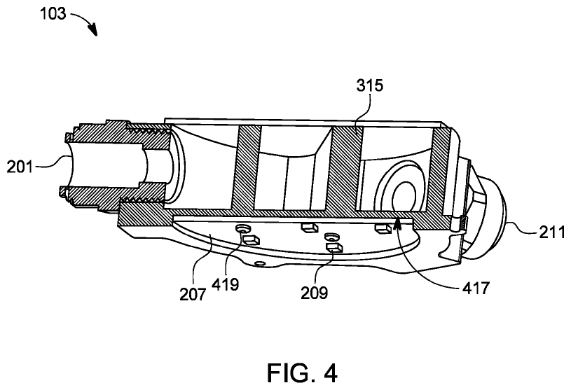

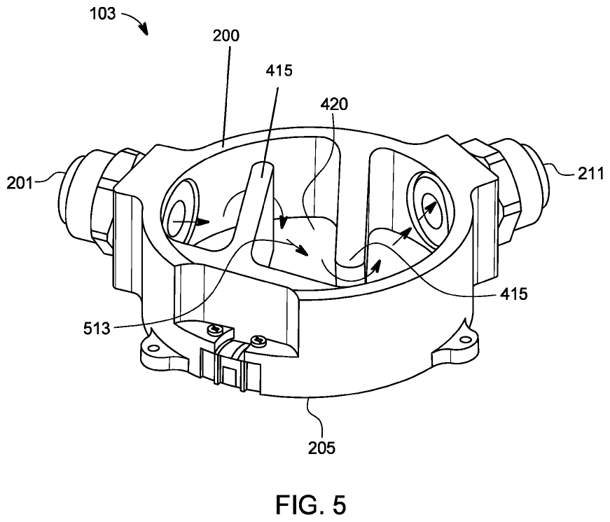

Now turning to FIGS. 4 and 5, which illustrates a cross-sectional view and an interior section of the heat sink 103. The housing 200 of the heat sink 103 comprises a substantially hollow body 420 with extension walls 415 of various patterns protruding inwardly from the cylindrical housing 200.

The hollow body 420 is designed to provide a space where fluids flow within the heat sink 103 and absorb the excess heat generated by the UV-C LED lights 209. The fluid flowing into and out of the heat sink 103 may be water or any other suitable fluid in need of temperature control and/or decontamination. The hollow body 420 defines a space where fluids are warmed and exit the hollow body 420 through the outlet 211, effectively removing heat from the heat sink 103, and thus, cooling the UV-C LED lights 209 associated therewith.

The hollow body 420 includes the extension walls 415, which define a fluid flow path and facilitate the flow of fluid within the heat sink 103. The extension walls 415 may be arranged in various patterns and configurations that are suitable for effective water flow and heat management. The extension walls 415 may each protrude from the housing 200 inwardly toward an opposing side of the housing 200. In some forms, the extension walls 415 are attached at one end and terminate prior to reaching the opposing side of the housing 200. In another embodiment, the extension walls 415 can be provided as solid core structures that project into the hollow body 420, creating a unique flow path for the fluids that flow in to and out of the heat sink 103. The extension walls may be composed of the same material as the rest of the heat sink, including any materials suitable for heat management. In some instances, there are two opposing extension walls extending inwardly from the housing 200 on opposing sides with respect to each other. In some forms, the extension walls extend inwardly and are imparted with a different length dimension, angle, or other parameter with respect to each other.

As seen in FIG. 4, a layer of thermal paste 417 is positioned between the interior surface 330 of the MCPCB 207 and the lower surface 205 of the heat sink 103. The thermal paste 417 is designed to secure the MCPCB 207 to the housing 200 and is configured to provide additional cooling to the water filtration system 100 by absorbing heat from the MCPCB 207 and transferring the heat to the hollow body 420. In some embodiments, only a thin layer of thermal paste 417 is used. The thermal paste 417 can be provided as a paste, a gel, a deformable solid, or combinations thereof. The thermal paste 417 may be made of thermally conductive elements such as silicone-based substances or paraffin wax.

Now turning to FIG. 5, the fluid flow path defined by the extension walls 415 within the heat sink 103 is depicted. The flow path 513 may be designed in any configuration to allow for fluid to flow into the heat sink 103 through the inlet 201, and out of the heat sink 103 through the outlet 211. The flow path 513 provides a serpentine space for the fluid to flow seamlessly while facilitating the flow of fluids into the heat sink 103 through the inlet 201, and out of the heat sink 103 through the outlet 211. In a preferred embodiment, the flow path 513 is a zig-zag configuration. In some embodiments, the flow rate of the fluid can be anywhere between about 0.5 GPM to about 2.5 GPM.

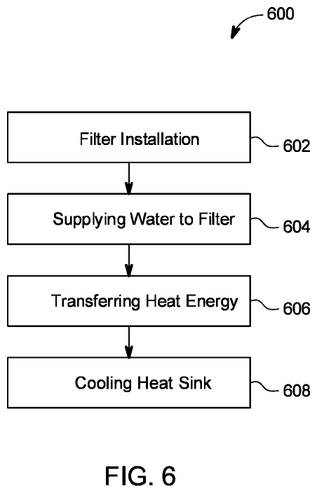

Now turning to FIG. 6, which illustrates a method 600 for cooling a water filtration system using a water-cooled heat sink. The method 600 may include a step 602 of installing a filter in a water filtration system. Water is supplied to the filter in a step 604. A step 606 of transferring heat energy to the water and a step 608 of cooling the heat sink are also included. Although the method 600 is illustrated in a specific order, the steps 602, 604, 606, and 608 may be performed in an alternative order, reverse order, or one or more of the steps 602, 604, 606, and 608 may be performed simultaneously, and/or omitted.

As described herein, a user or consumer may perform steps 602 and 604, and the water filtration system 100 (see FIGS. 1A-C) may perform steps 606, and 608 associated with method 600. It is to be understood, however, that other suitable systems may instead or also execute the method 600.

To begin executing the method 600, a user or consumer may begin at step 602 and install the water filtration system 100. For example, filter installation at step 602 may include shutting off the cold water to the household faucet by turning the cold water valve, under the sink, clockwise. Filter installation at step 602 may also include turning on the cold water faucet to release pressure and drain water from the hose. Filter installation at step 602 may also include inserting the new filter 101 into the base 107 of the water filtration system 100 by pressing and twisting the filter 101 in a clockwise direction to secure it into the base 107. An audible click ensures proper sealing of the filter 101 into the base 107. Filter installation at step 602 may also include opening the water shutoff valve by turning it counterclockwise. Filter installation at step 602 may also include allowing water to flow with the faucet completely open for fifteen minutes to flush the filter 101. Additionally, filter installation at step 602 may also include pressing and holding the indicator light button 104 for five seconds to confirm the fifteen-minute timer has started.

Once the water filtration system 100 has been successfully installed, a user or consumer may move on to step 604 and supply water to the water filtration system 100. A user may turn on the water to the sink connected to the water filtration system. A user may supply hot water and/or cold water to the water filtration system 100 to execute step 604.

At step 606, transferring heat energy may include the supplied water entering the water filtration system 100 through a hose (not illustrated) and further entering the heat sink 103 through the inlet 201. Transferring heat energy at step 606 may also include decontaminating and heating the supplied water as the supplied water flows through the flow path 513 defined by the extension walls 415 in the hollow body 420 of the heat sink 103. The supplied water is then decontaminated and heated by using the UV-C LED lights 209 fastened to the MCPCB 207 disinfection technology where UV-C photons are emitted through the water that penetrate the cells of bacteria and damage the nucleic acid in the microorganism's DNA.

At step 608, cooling the heat sink may include the heated water exiting the heat sink 103 through the outlet 211. The decontaminated and heated water continues through the fluid flow path 513 until it exits the heat sink 103 at the outlet 211. Once the heated water has exited the heat sink 103, the heat is removed from the heat sink 103 and it assists in maintaining a safe operating temperature.

Below, table 1 is the experimental data derived from tests run on an exemplary embodiment of the disclosed heat sink. The first column indicates the amount of time, in minutes, that water flowed through the heat sink 103. The third, fourth, and fifth columns indicate the temperature taken at UV-C LED 1, UV-C LED 2, and UV-C LED 4, respectively.

TABLE 1

| Time | Temperature, C. | | |
|---|---|---|---|
| (Min.) | LED 1 | LED 2 | LED 4 |
| 0 | 23.1 | 25.2 | 26.7 |
| 1 | 32.8 | 31.1 | 31.8 |
| 2 | 32 | 31.1 | 31.2 |
| 3 | 31.9 | 31 | 30.6 |
| 4 | 31.8 | 30.6 | 30.8 |
| 5 | 32.2 | 31.2 | 30.7 |

The test data shows that the heat sink 103 was able to maintain the temperature of the tested UV-C LED lights between 23.1° C. to 32.8° C., well below the safe operating temperature of 60° C., during the 5-minute test run.

Below, Table 2 is another graphical representation of the test data above in line graph form. The graph shows the progression of the temperature of each LED light over time.

Although the water filtration system 100 is depicted as an under-sink point of use system, the heat sink disclosed herein may be used in a variety of water filtration systems including, for example, any UV water disinfection system, under-sink and countertop filtration, ice machines, or other residential or commercial systems designed to provide drinking water, ice, or other potable water.

The previous description of the disclosed embodiments is provided to enable any person skilled in the art to make, use, or practice the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

Specific embodiments of a system and method for solar panel installation according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A water filtration system, comprising:
a filter designed to filter water;
a base that releasably connects to the filter, and includes an indicator light button and a filter release button; and
a heat sink disposed within the base that includes a plurality of UV-C LEDs.

2. The water filtration system of claim 1, wherein the heat sink is defined by a housing having an upper surface and a lower surface, and an inlet, an outlet, and an electrical seat connector circumscribing the housing and positioned between the inlet and the outlet.

3. The water filtration system of claim 2, wherein the heat sink includes a metal core printed circuit board positioned on the lower surface of the heat sink.

4. The water filtration system of claim 3, wherein the metal core printed circuit board is defined by an inside surface and an outside surface opposite the inside surface, the plurality of UV-C LEDs directed toward the outside surface of the metal core printed circuit board.

5. The water filtration system of claim 4, wherein the metal core printed circuit board is secured to the housing via a plurality of metal core printed circuit board fasteners.

6. The water filtration system of claim 4, wherein the heat sink further includes a thermal paste positioned between the lower surface of the heat sink and the inside surface of the metal core printed circuit board.

7. The water filtration system of claim 2, wherein the heat sink defines a hollow body having two extension walls protruding inwardly from the housing to define a fluid flow path positioned between the inlet and the outlet.

8. The water filtration system of claim 3, wherein the heat sink further includes an electrical connector retained in the electrical seat connector by a plurality of electrical connector fasteners, and wherein the electrical connector is in electronic communication with the metal core printed circuit board and the heat sink.

9. A water filtration system, comprising:
a filter configured to decontaminate a fluid that flows in and out of the system;
a base to retain the filter, the base having at least one of an indicator light button or a filter release button; and
a UV-C reactor heat sink disposed within the base and configured to transfer heat energy out of the UV-C reactor heat sink.

10. The water filtration system of claim 9, wherein the indicator light button communicates a status of the filter.

11. The water filtration system of claim 9, wherein the filter release button is designed to release the base from the filter.

12. The water filtration system of claim 9, wherein the UV-C reactor heat sink further comprises:
an inlet configured to allow fluids to flow into the UV-C reactor heat sink; and
an outlet configured to allow the fluids to flow out of the UV-C reactor heat sink.

13. The water filtration system of claim 12, wherein the UV-C reactor heat sink further comprises a plurality of UV-C LED lights operatively connected to a metal core printed circuit board, wherein the plurality of UV-C LED lights are configured to disinfect the fluids flowing through the UV-C reactor heat sink.

14. The water filtration system of claim 13, wherein the UV-C reactor heat sink further comprises an electrical connector configured to supply electrical power to the plurality of UV-C LED lights.

15. The water filtration system of claim 14, wherein the UV-C reactor heat sink further comprises a substantially hollow body with extension walls, wherein the hollow body is configured to provide a space for fluid to flow within the UV-C reactor heat sink, and absorb excess heat generated by the plurality of UV-C LED lights.

16. The water filtration system of claim 15, wherein the hollow body defines a fluid flow path formed by the extension walls, and the fluid flow path is configured to facilitate the flow of fluids into and out of the UV-C reactor heat sink.

17. The water filtration system of claim 16, wherein the extension walls are provided in the form of two opposing extension walls extending inwardly from the hollow body.

18. The water filtration system of claim 17, wherein the extension walls are provided in the form of a first extension wall and a second opposing extension wall extending inwardly from a housing of the hollow body, and the first extension wall being imparted with a different length than the second extension wall.

19. The water filtration system of claim 18, wherein the first extension wall and the second opposing extension wall are imparted with substantially the same thickness with respect to each other.

20. A method for cooling a water filtration system, the method comprising:
installing a filtration system;
supplying water to the filtration system;
transferring heat energy to the water supplied to the filtration system;
cooling a UV-C reactor heat sink; and
decontaminating the supplied water to the filtration system using UV-C LED disinfection technology after the water has passed through the UV-C reactor heat sink.
